(19) United States
(12) Patent Application Publication
(10) Pub. No.: US 2006/0098466 A1
(43) Pub. Date: May 11, 2006

(54) Demagnetization circuit for using in push-pull circuit

(76) Inventor: Chun-Ching Chang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/981,650

(22) Filed: Nov. 5, 2004

(51) Int. Cl. H02M 3/335

(52) U.S. Cl. 363/25

(57) ABSTRACT

A demagnetization circuit that is used in a push-pull circuit, when the positive-half-period circuit is on and the negative-half-period circuit is off, a pulse width modulation signal (Vga) at MOSFET side of the positive-half-period circuit is inversed (PWB) and then transmitted into negative-half-period demagnetization circuit, which renders the negative-half-period demagnetization circuit conducted and short so that the demagnetization is operated during the positive-half-period; when the negative-half-period circuit is operating, a pulse width modulation signal (Vgb) at MOSFET side of the negative-half-period circuit is inversed (PWB) and then transmitted into positive-half-period demagnetization circuit, and the above circuits are alternatively switched and short for demagnetization so as to prevent the transformer from generating remanent magnetization.

### BACKGROUND OF THE INVENTION

1. Field of the Invention

A demagnetization circuit that is used in a push-pull circuit, when the positive-half-period circuit is on and the negative-half-period circuit is off, a pulse width modulation signal (Vga) at MOSFET side of the positive-half-period circuit is inversed (PWB) and then transmitted into negative-half-period demagnetization circuit, which renders the negative-half-period demagnetization circuit conducted and short so that the demagnetization is operated during the positive-half-period; when the negative-half-period circuit is operating, a pulse width modulation signal (Vgb) at MOSFET side of the negative-half-period circuit is inversed (PWB) and then transmitted into positive-half-period demagnetization circuit, and the above circuits are alternatively switched and short for demagnetization so as to prevent the transformer from generating remanent magnetization.

2. Description of Related Art

As technology develops with each passing day, computers are important to general enterprises and companies. For preventing data loss, most of enterprises and companies use uninterruptible power system (UPS) to prevent data loss when the electric power is cut out or the power is unsteady. Besides, the UPS can further be used as power supply and thus UPS now are necessary to general enterprises, companies, and even personal computers.

When direct current is transferred to alternating current in an uninterruptible power system, a push-pull circuit is used as rear output such that the positive-half-period circuit and negative-half-period circuit of the push-pull circuit can alternately output (when the positive-half-period circuit is on, the negative-half-period circuit is off) and use MOSFET (Metal-Oxide-Semiconductor Field Effect Transistor) to control on/off for oscillating and generating a sine wave comprised of positive-half-period and negative-half-period. However, during the on/off operation of positive-half-period MOSFET, the transformer will generate remanent magnetization due to the coil current linearly up and down while MOSFET is switched off. Remanent magnetization must be released, if not, MOSFET will release it when MOSFET is on, which renders the temperatures of MOSFET and transformer are raised. At this time, MOSFET cannot regulate the voltage and the magnetic core of the transformer is saturated, and the internal resistance will approach zero which makes a huge current and generates a burst or causes distortion at the output of the transformer (referring to FIG. 1) and thus the circuit is possible short. It is important for persons skilled in the art to efficiently removed remanent magnetization in the circuit.

However, because the push-pull circuit uses the characteristic of MOSFET, i.e. fast switching on/off, remanent magnetization energy will be generated without loop for releasing as MOSFET off, and thus another demagnetization design is needed; if another demagnetization manner is disposed in the uninterruptible power system, the whole circuit design will be complicated and the cost will relatively increase.

Consequently, because of the derivative defects from the conventional demagnetization method, the applicant keeps on carving unflaggingly through wholehearted experience and research to develop the demagnetization circuit of the present invention, which is more practical.

### SUMMARY OF THE INVENTION

The main object of the present invention provides a demagnetization circuit that is used in a push-pull circuit and directs pulse width modulation signals to the demagnetization circuit. When MOSFET is off, the demagnetization circuit is inversed so as to be conducted and short as a demagnetization loop for removing the remanent magnetization.

The second object of the present invention provides a demagnetization circuit for using in a push-pull circuit. The demagnetization circuit of the present invention efficiently removes the remanent magnetization of the transformer so as to prevent the transformer from being short.

Another object of the present invention provides a demagnetization circuit for using in a push-pull circuit. The demagnetization circuit is directly designed in the push-pull circuit and thus the design complexity and manufacture cost are reduced.

Another object of the present invention provides a demagnetization circuit for using in a push-pull circuit. The demagnetization circuit of the present invention removes the remanent magnetization of the transformer so as to prevent the output waveform from generating burst and distortion.

To achieve the above objects, the present invention, a pulse width modulation signal of the positive-half-period circuit is transmitted into negative-half-period demagnetization circuit when the positive-half-period circuit is on and the negative-half-period circuit is off, which renders the negative-half-period demagnetization circuit conducted and short so that the demagnetization is operated during the positive-half-period; when the negative-half-period circuit is operating, a pulse width modulation signal of the negative-half-period circuit is transmitted into positive-half-period demagnetization circuit, and the above circuits are alternatively switched and short for demagnetization so as to prevent the transformer from generating remanent magnetization and protect the transformer.

### BRIEF DESCRIPTION OF THE DRAWINGS

The drawings disclose an illustrative embodiment of the present invention which serves to exemplify the various advantages and objects hereof, and are as follows:

FIG. 1 is a schematic diagram that shows waveform change before demagnetization;

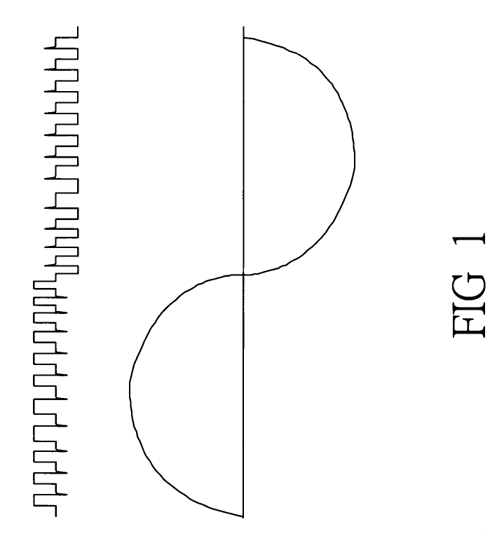

FIG. 2 is a schematic diagram that shows a demagnetization circuit of the present invention;

FIG. 3 is a schematic diagram that shows a negative-half-period demagnetization operation of the present invention;

FIG. 4 is a schematic diagram that shows a positive-half-period demagnetization operation of the present invention;

FIG. 5 is a schematic diagram that shows input and output signals of the present invention;

FIG. 6 is a schematic diagram that shows waveform change after demagnetization.

### SYMBOLS FOR THE FIGURES

| | |
|---|---|
| 1 | positive-half-period driving circuit |
| 2 | negative-half-period driving circuit |
| 3 | transformer |
| Q1 | First transistor |
| Q2 | Second transistor |
| Q3 | First transistor |
| Q4 | Second transistor |
| D1 | Diode |
| D2 | Diode |

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

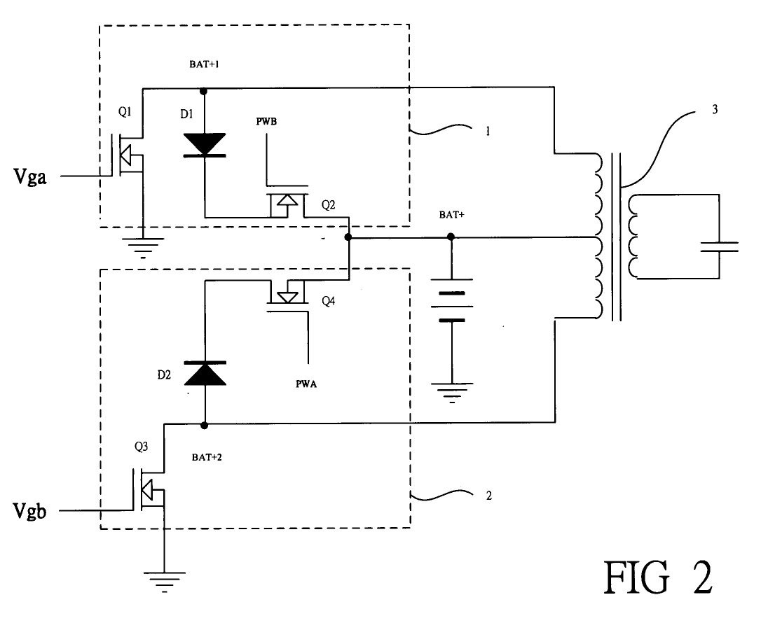

Referring to FIG. 2, which show a schematic diagram of a circuit of the present invention. The present invention relates to a demagnetization circuit for using in a push-pull circuit, the demagnetization circuit comprises:

a positive-half-period driving circuit 1 comprises a first transistor Q1 and a second transistor Q2 for modulating pulse width; a diode D1 for conduction;

a negative-half-period driving circuit 2 comprises a first transistor Q3 and a second transistor Q4 for modulating pulse width; a diode D2 for conduction; and

a transformer 3 connects to the positive-half-period driving circuit 1 and negative-half-period driving circuit 2 for outputting alternating current.

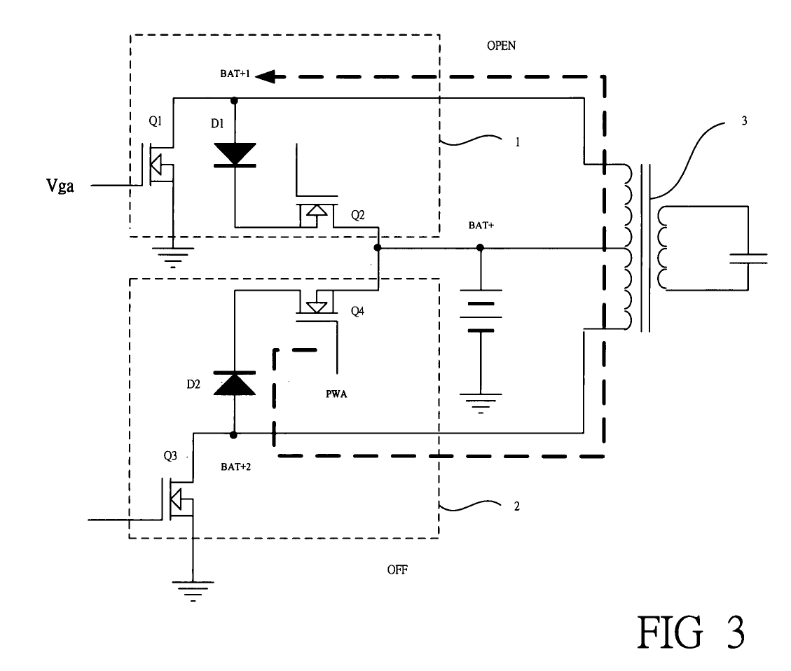

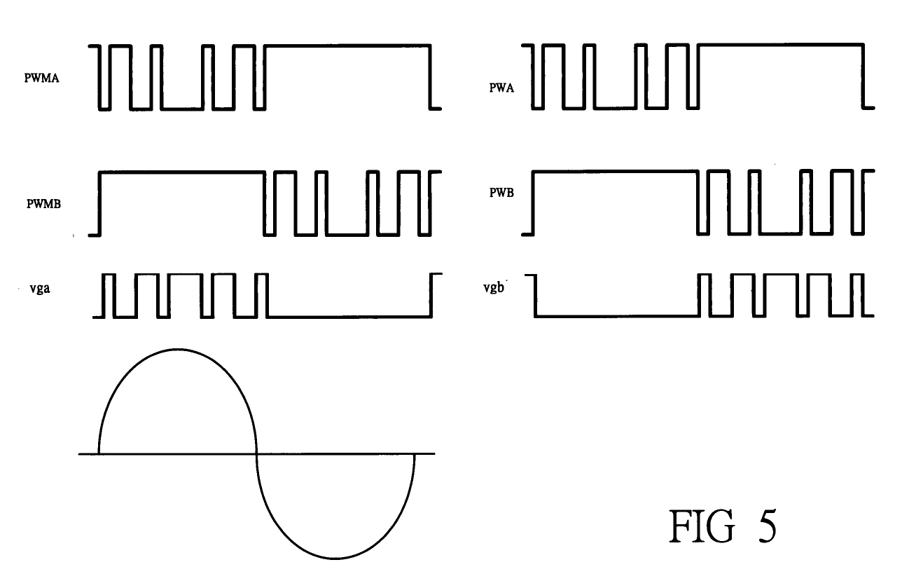

Referring to FIG. 3, it is a schematic diagram that shows a positive-half-period driving circuit of the present invention. Given the above description, when the positive-half-period driving circuit 1 is driven, the waveform thereof is a signal inverse to signal Vga. At this time, the negative-half-period driving circuit 2 is off and the signal Vga is transmitted from the first transistor Q1 of the positive-half-period driving circuit 1 to the transformer 3, the first transistor Q1 is conducted to output a positive-half-period sine wave via the transformer 3 for transmitting power; meanwhile, a signal PWA is input from one terminal of the second transistor Q2 (referring to FIG. 5), which is totally opposite to the waveform of the signal Vga. When the signal PWA is High, it drives the transistor Q4 and diode D2 of the negative-half-period driving circuit 2 to be conducted, and makes the input coils at middle point Bat+ and Bat+2 on the primary side of the transformer 3 short, which makes the positive-half-period driving circuit 1 and the negative-half-period driving circuit 2 short. Therefore, the remanent magnetization on the MOSFET of the positive-half-period driving circuit 1 can be removed, wherein the positive-half-period driving circuit 1 is off.

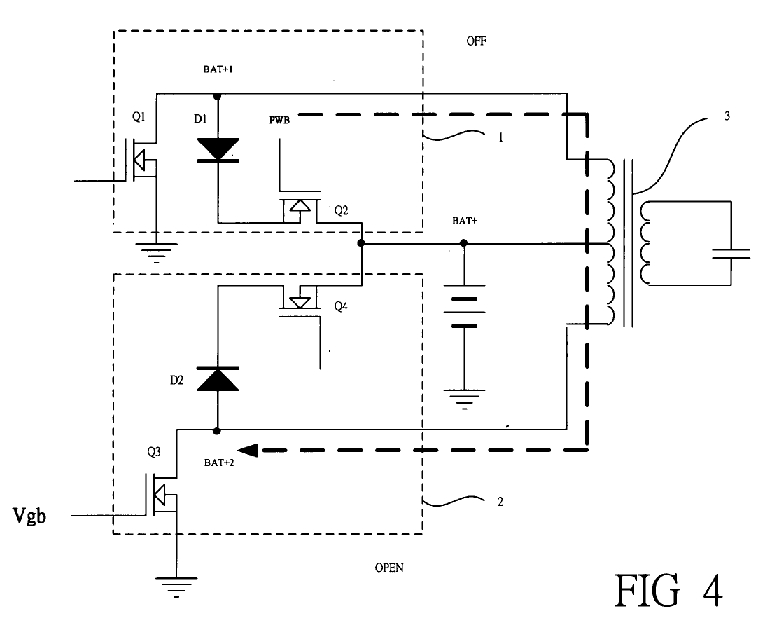

Referring to FIG. 4, it is a schematic diagram that shows a negative-half-period driving circuit of the present invention. When the negative-half-period driving circuit 2 is driven, the waveform thereof is a signal Vgb. At this time, the positive-half-period driving circuit 1 is off and the signal Vgb is transmitted from the first transistor Q3 of the negative-half-period driving circuit 2 to the transformer 3, the first transistor Q3 is conducted to output a negative-half-period sine wave via the transformer 3 for transmitting power; meanwhile, a signal PWB is input from one terminal of the second transistor Q4 (referring to FIG. 5), which is totally opposite to the waveform of the signal Vgb. When the signal PWB is High, it drives the transistor Q2 and diode D1 of the positive-half-period driving circuit 1 to be conducted, and makes the input coils at middle point Bat+ and Bat+1 on the primary side of the transformer 3 short, which makes the negative-half-period driving circuit and the positive-half-period driving circuit 1 short. Therefore, the remanent magnetization on the MOSFET of the negative-half-period driving circuit 2 can be removed, wherein the negative-half-period driving circuit 2 is off.

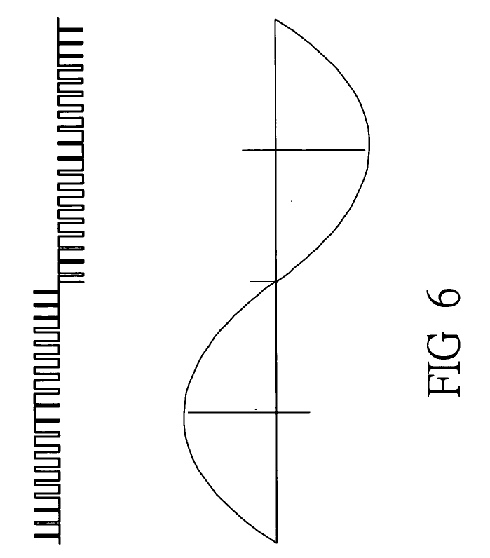

Referring to FIG. 6, it is a schematic diagram that shows a demagnetized waveform of the present invention. The demagnetization method directs the operating electrical signal to the off circuit and makes it conducted and short so as to remove the remanent magnetization and prevents the burst and distortion from appearing in the output waveform of transformer 3. The present invention can remove the remanent magnetization, which causes the MOSFET overheated and unworkable and the makes the transformer 3 short. Therefore, the push-pull circuit needs no further demagnetization design and the circuit design in the whole uninterruptible power system is more simplified. Thus, complexity of design and the manufacture cost can be reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

Given the above, the present invention is innovative in space and has the above effects as compared to the conventional products. The present invention really has novelty and inventive step and completely meets the applied element of new inveniton patent. The applicant applied for the present invention according to the Patent Law and the subject application should be examined in detail and granted a patent right to protect the inventor's right.

What is claimed is:

1. A demagnetization circuit for using in a push-pull circuit comprising:
a positive-half-period driving circuit comprising a first transistor and a second transistor for modulating pulse width; a diode for conduction;
a negative-half-period driving circuit comprising a first transistor and a second transistor for modulating pulse width; a diode for conduction; and
a transformer connecting to the positive-half-period driving circuit and negative-half-period driving circuit for outputting alternating current.

2. The demagnetization circuit of claim 1, wherein a terminal of the second transistor of the positive-half-period driving circuit can be input a signal PWB.

3. The demagnetization circuit of claim 2, wherein the waveform of the signal PWB is the same with that of signal PWMB.

4. The demagnetization circuit of claim 1, wherein a terminal of the second transistor of the negative-half-period driving circuit can be input a signal PWA.

5. The demagnetization circuit of claim 4, wherein the waveform of the signal PWA is the same with that of signal PWMA.
